(19) United States
(12) Patent Application Publication
(10) Pub. No.: US 2021/0117890 A1
(43) Pub. Date: Apr. 22, 2021

(54) EQUIPMENT REPAIR SYSTEM AND METHOD

(71) Applicant: GE Global Sourcing LLC, Norwalk, CT (US)

(72) Inventors: Nicholas Christopher, Erie, PA (US); Leonardo Silvestri, Ellicott City, MD (US)

(21) Appl. No.: 16/656,731

(22) Filed: Oct. 18, 2019

(51) Int. Cl. G06Q 10/06; G05B 23/02; G06Q 10/00; G06Q 10/08; G06Q 30/02; G06F 11/34

(52) U.S. Cl. CPC G06Q 10/06315; G05B 23/0283; G06F 11/3409; G06Q 10/087; G06Q 30/02; G06Q 10/20

(57) ABSTRACT

Systems and methods for identifying a bad actor component needing repair or replacement are provided. The systems and methods can track unscheduled shopping events for maintenance or repair of equipment and identify a segment of the unscheduled shopping events. The segment represents a period of time during which the unscheduled shopping events occurred at a rate or frequency. A usage metric of parts in connection with the unscheduled shopping events occurring during the segment is determined. The usage metric indicates a cumulative amount of usage of the parts in connection with the unscheduled shopping events during the segment for the equipment relative to the cumulative amount of usage of the parts in connection with the unscheduled shopping events for other equipment during one or more other segments of equal length. The bad actor component in the equipment is identified based on the usage metric that is determined.

### BACKGROUND

### Technical Field

The subject matter described herein relates to monitoring equipment to determine whether, when, and/or how to repair the equipment.

### Discussion of Art

Equipment may require maintenance or repair over time. Performing this maintenance or repair can involve replacing components of the equipment and/or using materials to complete the maintenance or repair. For example, a faulty component may be replaced during a repair action of the equipment, oil or coolant may be needed to replenish a reduced amount of oil or coolant in the equipment, etc.

Some equipment may have a component that needs repair or replacement, but detection of this component may be difficult. For example, the symptoms of a component needing repair or replacement may not be readily associated with or identified with the component. Instead, these symptoms may point to other components needing repair or replacement. These other components may be repeatedly repaired or replaced in a needless manner in an effort to identify the cause of the deteriorated or faulty performance of the equipment.

This can result in a prolonged search for the equipment component that is causing deteriorated or faulty performance of the equipment. This prolonged search can add significant cost, wasted part and material inventory, and extended downtime to the maintenance of the equipment.

### BRIEF DESCRIPTION

In one example of the inventive subject matter described herein, a method (e.g., for identifying a bad actor component needing repair or replacement) is provided that includes tracking unscheduled shopping events for maintenance or repair of first equipment and identifying a segment of the unscheduled shopping events that are tracked. The segment represents a period of time during which the unscheduled shopping events occurred at a rate or frequency. The method also includes determining a usage metric of one or more parts in connection with the unscheduled shopping events occurring during the segment. The usage metric indicates a cumulative amount of usage of the one or more parts in connection with the unscheduled shopping events during the segment for the first equipment relative to the cumulative amount of usage of the one or more parts in connection with the unscheduled shopping events for other equipment in a set of equipment during one or more other segments of equal length. The method also includes identifying a bad actor component in the first equipment based on the usage metric that is determined.

In another example of the inventive subject matter described herein, a method includes determining unscheduled shopping events for maintenance or repair of first equipment and usage metrics of parts used in the unscheduled shopping events, comparing one or more of the unscheduled shopping events or the usage metrics of the first equipment with a predefined signature of one or more of unscheduled shopping events or usage metrics of other equipment, determining that the one or more of the unscheduled shopping events or the usage metrics of the first equipment match the signature, and instructing repair or maintenance of the first equipment based on the one or more of the unscheduled shopping events or the usage metrics of the first equipment matching the signature.

In another example of the inventive subject matter described herein, a system (e.g., that identifies a component in need of repair or replacement) includes one or more processors configured to track unscheduled shopping events for maintenance or repair of first equipment and to identify a segment of the unscheduled shopping events that are tracked. The segment represents a period of time during which the unscheduled shopping events occurred at a rate or frequency. The one or more processors also are configured to determine a usage metric of one or more parts in connection with the unscheduled shopping events occurring during the segment. The usage metric indicates a cumulative amount of usage of the one or more parts in connection with the unscheduled shopping events during the segment for the first equipment relative to the cumulative amount of usage of the one or more parts in connection with the unscheduled shopping events for other equipment in a set of equipment during one or more other segments of equal length. The one or more processors are configured to identify a bad actor component in the first equipment based on the usage metric that is determined.

### BRIEF DESCRIPTION OF THE DRAWINGS

The inventive subject matter may be understood from reading the following description of non-limiting embodiments, with reference to the attached drawings, wherein below:

FIG. 1 illustrates one example of an equipment repair system;

FIG. 2 illustrates a flowchart of one embodiment of a method for identifying a bad actor component of equipment;

FIG. 3 illustrates a graphical user interface (GUI) that can be generated by a tracking controller shown in FIG. 1 to present unscheduled shopping events and usage metrics; and

FIG. 4 illustrates a flowchart of one embodiment of a method for predicting bad actor components of equipment.

### DETAILED DESCRIPTION

Embodiments of the subject matter described herein relate to systems and methods that track unscheduled shopping events in the maintenance and/or repair of equipment. A shopping event can involve inspecting, repairing, replacing, or otherwise taking equipment out of service or usage (e.g., taking the equipment to a repair shop or facility). The shopping events may be unscheduled in that the order or need for repair or maintenance of equipment may not occur during a previously scheduled or established schedule for repair or maintenance of the equipment. The shopping event may involve replacing parts and/or using material to repair or maintain the equipment, or may involve an inspection or other action performed on the equipment without replacing parts and/or material.

In one embodiment, the cumulative part and/or material usage for first equipment over a segment of unscheduled shopping events is tracked to determine whether the cumulative usage is large when compared to other equipment in a group of equipment that also includes the first equipment (e.g., a fleet of equipment, all equipment owned by the same entity, etc.). Cumulative usage that is relatively large (e.g., at or above the ninetieth percentile) indicate a problem with the first equipment (e.g., a bad actor component), which may need to be addressed to reduce further large cumulative usage of parts and/or materials.

Optionally, in the same embodiment or another embodiment, the shopping events for equipment can be tracked over time to determine whether a change point occurs. The number of unscheduled shopping events per unit of time can be tracked over a period of time. For example, the number of unscheduled shopping events per month can be tracked.

Bad actor equipment can be identified by determining whether the segments' rates of unscheduled shopping events increase above a threshold level, such as the ninetieth percentile of the average number of unscheduled shopping events for the group or set of equipment. This group or set of equipment can include all equipment in a fleet, all equipment owned by the same entity (e.g., a customer), all equipment of the same make and/or model, etc.

If the segments' rates of unscheduled shopping events for equipment extend above or cross a threshold (e.g., the ninetieth percentile), then the equipment is identified as a bad actor. Additional unscheduled shopping events may be monitored to determine whether the segments of unscheduled shopping events for the equipment drop below the threshold.

In one embodiment, a bad actor segment of unscheduled shopping events can be identified. This segment can include or be defined as the unscheduled shopping events occurring after the increasing change point, between the increasing and decreasing change points, or a segment that does not have any change points (but that includes large amount of unscheduled shopping events). The bad actor segment also can be referred to as a bad actor period. At each unscheduled event in the segment, the system and method can examine the material and/or part usage within this segment to determine the cumulative usage. For example, the unscheduled shopping events can involve replacement of parts, consumption of materials, etc. The aggregate amount of part and/or material usage across the unscheduled shopping events occurring within the bad actor segment for the equipment being analyzed is compared with the aggregate amount of part and/or material usage across the unscheduled shopping events occurring within the bad actor segment for the equipment in the set (e.g., all other equipment or all equipment). For example, the aggregate amount of usage for each part or material used for the first piece of equipment during the bad actor segment can be divided by the number of unscheduled shopping events during the bad actor segment to calculate a usage metric or analytic. This usage metric is calculated for the equipment in the set (e.g., all equipment or all equipment other than the first equipment) and the usage metrics for each part or material consumed for the unscheduled shopping events of the first piece of equipment are compared to a distribution of the usage metrics for the corresponding part or equipment consumed for the unscheduled shopping events for the equipment in the set. If the usage metric for a part or material used for the first piece of equipment exceeds a threshold (e.g., is at the ninetieth percentile or more of all equipment), then the component for which this part or material was used can be identified as a bad actor component of the equipment. The identified bad actor component may then be repaired, maintained, or replaced.

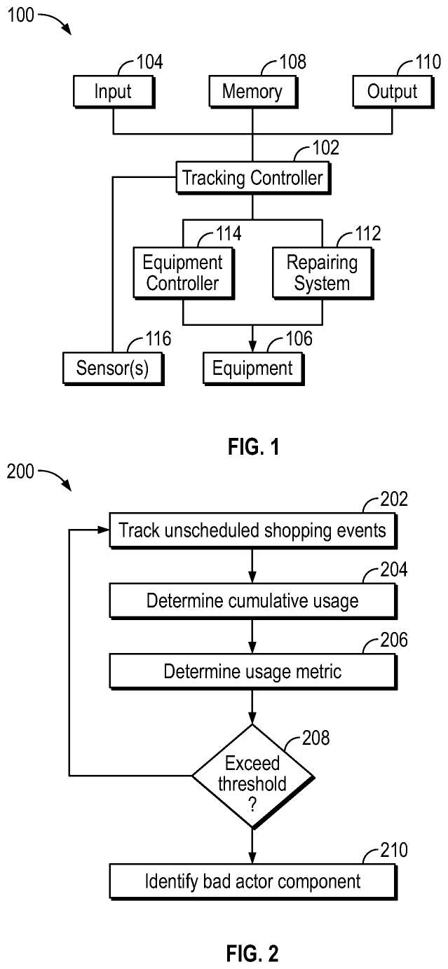

FIG. 1 illustrates one example of an equipment repair system 100. The repair system includes a tracking controller 102 that represents hardware circuitry including and/or connected with one or more processors (e.g., one or more microprocessors, field programmable gate arrays, integrated circuits, or the like) that perform the operations described herein in connection with the tracking controller. The tracking controller monitors unscheduled shopping events for maintenance or repair of equipment 106. An input device 104 can be used by the tracking controller to receive information (e.g., messages, signals, etc.) that includes or is associated with requests for shopping (e.g., maintenance, repair, inspection, etc.) of the equipment, which may or may not include usage of parts and/or materials in the shopping of the equipment. The shopping of the equipment can involve moving the equipment into a shop (e.g., a repair facility) for the repair, inspection, or maintenance of the equipment. The input device can represent one or more of a keyboard, microphone, disk drive, universal serial bus (USB) port, or the like, that receives information or signals indicating whether shopping is requested, which parts and/or materials are requested, and/or how much or how many of the parts and/or materials are requested. Optionally, the input device can represent communication circuitry that receives signals via wired and/or wireless connections that indicate the parts and/or materials that are requested. For example, the input device can include transceiving circuitry, an antenna, a modem, etc., for receiving these signals from another device.

With continued reference to the equipment repair system shown in FIG. 1, FIG. 2 illustrates a flowchart of one embodiment of a method 200 for identifying a bad actor component of equipment. The method 200 can represent operations performed by various components of the equipment repair system, as described herein. At 202, unscheduled shopping events are tracked. The unscheduled shopping of equipment can involve repairing, inspecting, and/or maintaining equipment that occurs outside of a predetermined schedule or that is identified as unscheduled. The unscheduled shopping of equipment can involve usage of parts and/or materials, such as where parts are replaced and/or materials replenished during the repair, inspection, and/or maintenance of the equipment. Optionally, the unscheduled shopping of equipment may not involve usage of parts and/or materials, such as where parts are not replaced or materials are not replenished during the repair, inspection, and/or maintenance of the equipment. The equipment can represent various systems such as vehicles, medical devices, stationary power generating devices (e.g., turbines), computers, motors, pumps, etc. The parts can be portions of the equipment and the materials can be consumable items such as coolant, lubricant, coating, etc.

The tracking controller can monitor the unscheduled shopping events for equipment over time, as well as the parts and/or materials used in the shopping events (to the extent parts and/or materials are used in the shopping event). This information can be stored as shopping event information in a tangible and non-transitory computer readable storage medium 108 (“memory” in FIG. 1), such as a local or remotely located computer hard drive, removable disk, optical drive, etc. As described herein, different items or pieces of information may be associated with each other. This association can be recorded in the memory for retrieval by the tracking controller.

In one example, shop personnel can use the input device to provide identifications (e.g., unique codes) to the tracking controller that identify the request for a shopping event (also referred to as a shopping event). The information that is provided optionally may identify the part(s) and/or material(s) used or to be used in the shop event. Alternatively, the part(s) and/or material(s) used in the shop event can be input after and/or during the shop event. Some identifications can indicate that the request for the shop event is a scheduled shop event, while other identifications can indicate that the request for the shop event is an unscheduled shop event. The shop event may be unscheduled when the shop event does not occur during a previously defined or previously established schedule. As one example, a vehicle may have a predetermined schedule that dictates when engine oil is replaced, when tires are rotated or replaced, when brake pads are replaced, etc. A medical imaging device may have a predetermined schedule that dictates when the imaging device is cleaned, when the imaging device is examined for accuracy, etc. The predetermined schedule may be an absolute schedule in which the times at which the equipment is to be maintained using parts and/or materials is set regardless of usage of the equipment. Additionally or alternatively, the predetermined schedule may be a relative schedule in which the times at which the equipment is to be maintained using parts and/or materials is set based on usage of the equipment (e.g., with more frequency maintenance potentially needed for greater usage of the equipment).

In one example, the tracking controller can determine whether a shopping event is an unscheduled shopping event based on the identification (e.g., code) provided by the shop personnel. For example, the code provided by the shop personnel may be compared (by the tracking controller) to a look-up table stored in the memory. This table can associate different codes with whether the shop event is a scheduled or unscheduled event. In another example, the tracking controller can determine whether the shopping event is scheduled or unscheduled by comparing a schedule associated with the equipment with the shopping order. If the shopping event occurs outside of this schedule, then the tracking controller can identify the shopping event as unscheduled. Optionally, the shopping event can be identified as an unscheduled shopping event based on prognostics of the equipment. For example, the tracking controller can examine performance of the equipment (e.g., output of the equipment, such as horsepower, current, data rate, etc.) and the age of the equipment, and determine whether the shopping event is unscheduled if the performance should be greater than measured due to the age of the equipment.

At 204, usage of parts and/or materials during at least some of the unscheduled shopping events is determined. As described above, an unscheduled shopping event can involve the usage of parts and/or materials when parts are replaced or repaired on or in the equipment. Not all unscheduled shopping events involve the usage of parts and/or materials, however. The tracking controller can receive input from the input device indicating which parts and/or materials, and how many or how much of the materials are used during the unscheduled shopping events. The tracking controller can separately aggregate the numbers of each part and/or material used, installed on, or otherwise consumed during the unscheduled shopping events within a segment. For example, for each part that was replaced on the equipment during the unscheduled shopping events during the same segment, the tracking controller can add up how many of each part was used during the segment.

At 206, one or more usage metrics are determined for the parts and/or materials. As described above, the usage metrics can indicate how much of the parts and/or materials is being used during the unscheduled shopping events of the equipment compares with how much of the same parts and/or materials is being used during all segments of equal length of the unscheduled shopping events for all equipment or the other equipment in the set. The tracking controller can determine a usage metric for a first part and the equipment being examined based on the cumulative usage of the first part and the number of unscheduled shopping events involving the equipment being examined.

For example, the tracking controller can add up how many of the first part were replaced, consumed, or otherwise used during the unscheduled shopping events for the equipment being examined over the course of the bad actor period (or another longer or shorter time period). At each unscheduled shopping event in the segment, the tracking controller can then calculate the usage metric by dividing this cumulative amount of usage of the first part by the number of unscheduled shopping events during this time period. The tracking controller can determine this usage metric for one or more (or all) other parts and/or materials. The tracking controller can determine this usage metric for the first part but for each of one or more (or all) other equipment in the set of equipment. The usage metric can be calculated for each of the parts and/or materials used for the other equipment over all segments of equal length.

At 208, a determination is made as to whether the usage metric for one or more parts and/or materials of the equipment being examined exceeds one or more thresholds. In one embodiment, the tracking controller determines a distribution of the usage metrics for the same part for the equipment in the set at the same segment length. The tracking controller determines whether the usage metric for the same part used in the equipment being examined exceeds a threshold in this distribution. For example, the tracking controller can determine whether this usage metric is within the ninetieth percentile or greater, is within the seventy-fifth percentile or greater, or the like.

If the usage metric for one or more parts and/or materials exceeds the threshold, then flow of the method 200 can move toward 210 to identify a bad actor component. Otherwise, flow of the method 200 can return toward 202 as no bad actor component is identified. This can allow the tracking controller to examine additional unscheduled shopping events and part/material usage to try to identify a bad actor component.

At 210, a bad actor component of the equipment being examined is identified. The bad actor component can be a part or component (formed of two or more parts) of the equipment that is the cause or root cause of at least some of the part and/or material usage during the unscheduled shopping events over the course of the bad actor period.

In one embodiment, the tracking controller can examine combinations of the usage metrics to identify the bad actor component. The tracking controller can examine combinations of two or more of the usage metrics to identify the bad actor component. Multiple usage metrics associated with different parts and/or the same unscheduled shopping events can be associated with the same component. For example, the parts involved in the unscheduled shopping events can all operate in connection with the same component. The replacement of a combination of parts associated with the same component can indicate that this component is the cause of the unscheduled shopping events. This component can be identified as the bad actor component.

The tracking controller can use the usage metrics to determine a signature of a bad actor component. The signature can be a series of usage metrics associated with a component being a bad actor component. Optionally, the signature can be a sequence of two or more usage metrics (for the same or different parts) and/or unscheduled shopping events and times at which the unscheduled shopping events occurred. For example, the signature can be the order in which the usage metrics and/or unscheduled shopping events occurred, and/or the times associated with the unscheduled shopping events.

The signature can be determined by identifying which usage metrics appear or are identified together for the same bad actor component among several of the equipment in the set. For example, if several pieces of the same make and model of the equipment are found to have the same bad actor component, then the tracking controller can determine whether these pieces of equipment have common usage metrics among one or more parts and/or materials. The signature can be later used to proactively identify what combinations of usage metrics indicate that a component of equipment may need repair or maintenance before having an increase in the unscheduled shopping orders.

The signature can be defined by which parts and/or materials are requested at the same time (during the same submission of shopping order(s)). For example, the request of parts A, B, and C at the same time or in the same unscheduled shopping order can be associated with a first equipment component being the bad actor component. Different signatures can define different combinations of parts and/or materials that are ordered together or at the same time (e.g., during the same maintenance action performed on the equipment).

The signature optionally can be defined by a temporal sequence of changes in requests for different parts and/or materials. For example, an increase in the requests for part D, followed by a decrease in the requests for material E, followed by an increase in the requests for part F may define one signature, while a change in requests for material G followed by a change in the requests for part H may define a different signature. Different signatures can be associated with different bad actor components.

The signature optionally can be defined by the frequency at which a part and/or material is requested. Different signatures can be associated with different rates at which one or more parts and/or materials are requested via the unscheduled shopping orders. These different signatures can be associated with different bad actor components. Optionally, signatures can be defined by which group of parts and/or materials are requested in an unscheduled shopping request. Different groups of parts and/or materials can define the different signatures, with the different signatures associated with different bad actor components.

The signatures can be empirically determined. For example, the unscheduled shopping events and usage metrics can be tracked to identify the change points and the bad actor components. The tracking controller can examine the combinations of parts and/or materials in the unscheduled shopping orders occurring prior to the increasing change point, subsequent to the increasing change point but prior to the decreasing change point, and/or subsequent to the decreasing change point to determine the combinations of part and/or material usage metrics associated with the bad actor component. These combinations can define the signatures of unscheduled shopping orders and/or usage metrics associated with different bad actor components that are identified.

The tracking controller can notify an operator or maintenance personnel of which component is identified as the bad actor component. This notification can occur via the output to inform the operator or maintenance personnel of the bad actor component. Optionally, the tracking controller can use the signature that is identified for the same or other equipment going forward to prevent or reduce the number of unscheduled shopping orders that may occur before the bad actor component is identified and replaced or otherwise remediated.

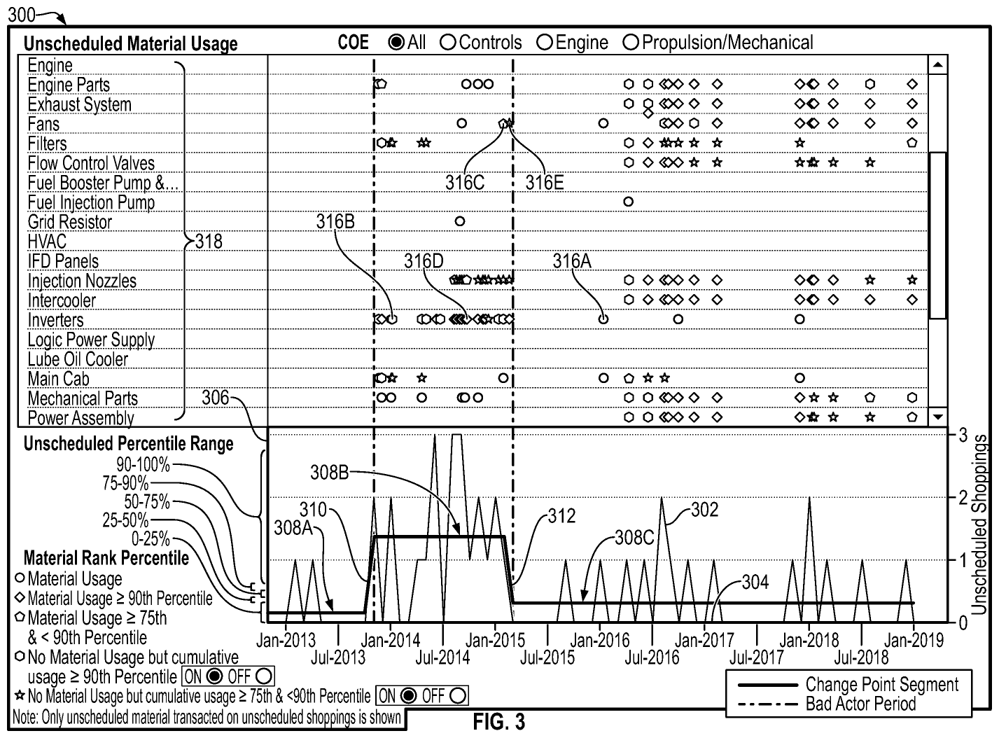

FIG. 3 illustrates a GUI 300 that can be generated by the tracking controller shown in FIG. 1 to present unscheduled shopping events and usage metrics. The tracking controller can direct an output device 110 (“output”) in FIG. 1 to present the GUI of FIG. 3, such as an electronic display or monitor. A plot 302 of unscheduled shopping events for a piece of equipment being analyzed is shown alongside a horizontal axis 304 representative of time and a vertical axis 306 representative of a number of unscheduled shopping events. The plot represents how many unscheduled shopping events were ordered or occurred for the equipment being analyzed.

The tracking controller can identify several segments 308 (e.g., segments 308A-C) based on the number of unscheduled shopping events. Each segment can be identified by the change point analytic. Using the time series of unscheduled shopping events for the equipment being studied, the analytic tries several or all possible segmentations. Each segmentation can be evaluated for goodness of fit with a penalty function applied to the number of segments. In the illustrated example, the change point analytic identifies 3 different segments, 308A-C, separated by two change points, one increasing change point (308A to 308B) and one decreasing (308B to 308C).

The tracking controller can examine the segments to determine whether an increasing change point 310 occurs. The change point can be identified when multiple segments are determined from the change point analytic. It is when these segment(s) exceed the threshold (e.g., the ninetieth percentile) that the equipment is deemed a bad actor. The increasing change point can be identified as the point where the equipment transitions from a segment with a lower rate of unscheduled shopping events to a segment with a higher rate of unscheduled shopping events. The decreasing change point can be identified as the point where the equipment transitions from a segment with a higher rate of unscheduled shopping events to a segment with a lower rate of unscheduled shopping events.

In the example shown in FIG. 3, several icons 316A-E are shown alongside a list 318 of different parts and materials. Each of these icons is repeated and re-used several times for different parts and/or materials. The list includes descriptions of the various parts and/or materials that were or could have been used during the unscheduled shopping events for the equipment being analyzed (and, optionally, for other equipment in the same set of equipment). Examples of these parts and/or materials in the list include engine parts, fans, filters, braking grid resistors, fuel injection nozzles, and inverters. The different icons indicate how much of each respective part and/or material was used in the corresponding unscheduled shopping event. Some icons 316A-C indicate that a part or material was used during an unscheduled shopping event while other icons 316D-E indicate that a part or material was not used during the corresponding unscheduled shopping event, but was used during one or more prior unscheduled shopping events.

The icons are vertically positioned in FIG. 3 to the right of the respective part or material that was used or inspected. The icons are horizontally positioned in FIG. 3 above the horizontal axis to indicate when the respective part or material was used or inspected. Several icons vertically aligned with each other above the same position along the horizontal axis indicate that the corresponding parts and/or materials were used or inspected during the same unscheduled shopping event.

In the example shown in FIG. 3, the different icons 316A-E indicate different usage metrics for the listed parts and/or materials. The icon 316A indicates that the corresponding part and/or material was used in the corresponding unscheduled shopping event but that the cumulative usage of the part or material does not exceed one or more thresholds (e.g., a seventy-five percentile threshold for usage metrics of other equipment in the set, the ninetieth percentile threshold for usage metrics of other equipment in the set, etc.). The icon 316B indicates that the corresponding part and/or material was used in the corresponding unscheduled shopping event and that the cumulative usage metric of the part and/or material is at the ninetieth percentile or more (among other equipment). The icon 316C indicates that the corresponding part and/or material was used in the corresponding unscheduled shopping event and that the cumulative usage metric of the part and/or material is greater than or equal to the seventy-fifth percentile but less than the ninetieth percentile (among other equipment). The icon 316D indicates that the corresponding part and/or material was not used in the corresponding unscheduled shopping event but that the cumulative usage metric of the part and/or material is greater than or equal to the ninetieth percentile (among other equipment). The icon 316E indicates that the corresponding part and/or material was not used in the corresponding unscheduled shopping event but that the cumulative usage metric of the part and/or material is greater than or equal to the seventy-fifth percentile but less than the ninetieth percentile (among other equipment).

For example, as shown in FIG. 3, many unscheduled shopping events during the bad actor period involved the inspection and/or replacement of inverters. The multiple icons 316B used for the inverters during this time period indicates that many more inverters were replaced for this equipment than other equipment in the same set of equipment during or over all segments of equal length. This can indicate that some component to which the inverters are coupled is the bad actor component.

Optionally, the tracking controller can select the bad actor component from among the parts that were replaced just prior to the decreasing change point (and end of the bad actor period). For example, if several parts are replaced during the last unscheduled shopping event in the bad actor period, the tracking controller can select one of these parts as the bad actor component. Or, if several of these parts operate in connection with the same component, then this component can be identified as the bad actor component.

In the example shown in FIG. 3, the tracking controller can determine that many more inverters were replaced during the bad actor period than for other equipment in the set (indicated by the several icons 316B for the inverters during the bad actor period) and that more fans were replaced during the bad actor period than for other equipment in the set (indicated by the icons 316C, 316E for the fans just prior to the end of the bad actor period). These inverters might be failing because a fan is not sufficiently cooling the inverters (instead of the inverters failing for another reason or cause).

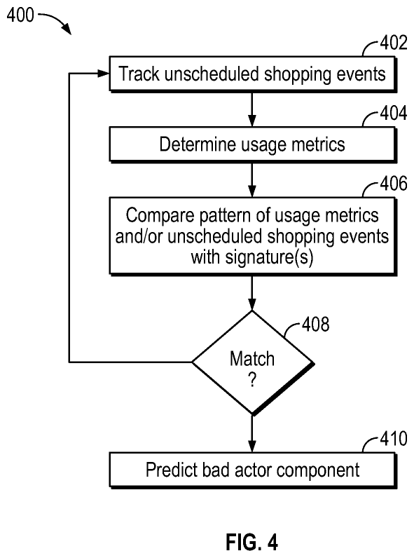

FIG. 4 illustrates a flowchart of one embodiment of a method 400 for predicting bad actor components of equipment. The method 400 can represent operations performed by the equipment repair system shown in FIG. 1. At 402, unscheduled shopping events for equipment under examination are tracked. The tracking controller can monitor the unscheduled shopping events similar to as described above. At 404, usage metrics are determined for the unscheduled shopping events. As described above, the tracking controller can calculate the usage metrics for various parts and/or materials that are used or inspected during the unscheduled shopping events. At 406, one or more patterns of the usage metrics and/or unscheduled shopping events are compared with one or more signature(s) associated with different bad actor components. A combination of one or more of frequencies in which the unscheduled shopping events occur, the parts and/or materials used in the unscheduled shopping events, the usage metrics for the different parts and when the usage metrics occur can be a pattern. Several different patterns can be compared with the signatures described above.

At 408, a determination is made as to whether any pattern matches a signature. If a pattern matches or otherwise corresponds with a signature, then the pattern of usage metrics and/or unscheduled shopping orders may indicate that the equipment has the same bad actor component associated with the signature. The tracking controller can compare the pattern(s) with multiple signatures and determine which signature has usage metrics and/or unscheduled shopping orders that match or more closely match the pattern(s). The signature that matches or more closely matches the pattern(s) may be selected by the tracking controller as a matching signature. As a result, flow of the method 400 can proceed toward 410 from 408. Alternatively, if the pattern does not match a signature, then flow of the method 400 can return toward 402 (e.g., to track additional shopping orders and determine when a pattern matches a signature).

At 410, a bad actor component is identified. Different bad actor components can be associated with different signatures. The tracking controller can select the bad actor component associated with the signature that matches the pattern as the bad actor component in the equipment being examined. The tracking controller can refer to the memory to determine which actions are associated with the signature to remediate the unscheduled shopping orders. With respect to the example described above in connection with FIG. 3, the tracking controller may determine that the alternator blower fan is to be replaced to prevent the continued, high frequency of unscheduled shopping orders replacing the inverters. The maintenance or repair can then be performed. For example, the tracking controller can communicate a signal (e.g., a notification signal, notice signal, control signal, warning signal, or the like) to an operator via the output to inform the operator of what maintenance or repair action to perform. As another example, the equipment repair system can communicate the signal to a repairing system 112 (shown in FIG. 1) that automatically implements the maintenance or repair. The repairing system can represent an automated system (e.g., a robotic system) that automatically replaces a part and/or material, or otherwise performs the maintenance or repair associated with the matching signature.

Optionally, another responsive action in addition to or in place of the maintenance or repair may be performed. For example, the tracking controller can change or direct a change to a movement schedule of the equipment responsive to determining that the unscheduled shopping orders match a signature. The tracking controller can communicate with the equipment (e.g., a vehicle) and instruct the vehicle to move to a shop facility instead of to another location for the repair or maintenance to be performed. For example, the tracking controller can send a signal to the vehicle to instruct an automatic control system of the vehicle or a driver of the vehicle to autonomously or manually deviate from a current route onto a different route that directs the vehicle to a repair facility.

This process can be useful in quickly identifying root causes of issues with equipment that otherwise could give rise to frequent unscheduled shopping orders. The process described above allows for the tracking controller to examine the culmulation of unscheduled shopping orders for first equipment, determine the bad actor component of the first equipment, and identify a signature associated with this bad actor component. The signature can then be used by the tracking controller to examine other usage metrics and/or unscheduled shopping events of other equipment and determine whether any other equipment has usage metrics and/or unscheduled shopping events that match this signature. If the other equipment does have usage metrics and/or unscheduled shopping events that match the signature, the tracking controller can quickly identify the bad actor component earlier in the life of the other equipment and repair or maintain the bad actor component to prevent frequent unscheduled shopping orders that may occur if the bad actor component is not identified and addressed earlier in the process.

The tracking controller can examine the usage metrics and/or unscheduled shopping events prior to or just after an increasing change point to quickly identify the bad actor component and reduce the amount of unscheduled shopping events and/or part usage. The tracking controller can determine that one or more patterns of usage metrics and/or unscheduled shopping events match one or more signatures associated with one or more bad actor components, as described above. From this determination, the tracking controller can identify the bad actor component(s) and instruct the remediation of the bad actor component(s). This identification and remediation may occur much earlier than without examining the unscheduled shopping orders and comparing the unscheduled shopping orders with the signatures, as the unscheduled shopping orders may be associated with parts that are not included or coupled with the bad actor component and/or the unscheduled shopping orders may be associated with materials that are not consumed or used by the bad actor component. This can cut down on wasteful consumption and cost of parts and materials that otherwise would be acquired via the additional unscheduled shopping orders that are avoided.

In one example, the tracking controller can examine the usage metrics and/or unscheduled shopping events occurring only before the increasing change point occurs to determine that at least some of the usage metrics and/or unscheduled shopping events match a signature. Stated differently, at least some of the unscheduled shopping events and/or usage metrics indirectly caused by the bad actor component may occur before the increasing change point is identified by the tracking controller. The tracking controller can recognize that a pattern in the usage metrics and/or unscheduled shopping orders before any increasing change point occurs match a signature associated with the bad actor component. The tracking controller can then identify the bad actor component based on this match and may remediate the bad actor component before the increasing change point occurs or shortly after the increasing change point occurs. This process can cut down on wasteful consumption and cost of parts and materials that otherwise would be acquired via the additional unscheduled shopping orders that are avoided.

The tracking controller can continue monitoring usage metrics and/or unscheduled shopping events after remediation of a bad actor component to monitor for evidence of additional bad actor components. The tracking controller can identify a first bad actor component based on at least some of the usage metrics and/or unscheduled shopping events, as described above. The tracking controller can then direct the repair or replacement of the first bad actor component (which can result in the usage metrics and/or frequency of unscheduled shopping events decreasing at a decreasing change point).

The tracking controller optionally can attempt multiple different responsive actions and/or identifying different bad actor components based on the pattern of usage metrics and/or unscheduled shopping events. For example, the tracking controller can monitor the usage metrics and/or unscheduled shopping events and identify a bad actor component. The tracking controller may then direct a first repair or maintenance action be performed on the equipment to remediate the effects of the bad actor component. The tracking controller may continue monitoring the usage metrics and/or unscheduled shopping events (e.g., to determine whether the decreasing change point occurs) responsive to completing the first repair or maintenance action.

If the decreasing change point does not occur, then the tracking controller can determine that the first repair or maintenance action did not remediate the bad actor component. The tracking controller can then direct that a different, second repair or maintenance action be performed. The different repair or maintenance actions can include replacing different parts of the equipment, disabling different functions of the equipment, using different materials in operation of the equipment (e.g., different coolants, different fuels, etc.), or the like. The tracking controller can continue monitoring the usage metrics and/or unscheduled shopping events to determine whether the bad actor component has been remediated or if another, different repair or maintenance action is to be implemented.

As another example, the tracking controller can monitor the usage metrics and/or unscheduled shopping events and identify a first bad actor component. The tracking controller may then direct that a repair or maintenance action (associated with the first bad actor component) be performed. The tracking controller may continue monitoring the usage metrics and/or unscheduled shopping events (e.g., to determine whether the decreasing change point occurs) responsive to completing this repair or maintenance action. If the decreasing change point does not occur, then the tracking controller can determine that the first bad actor component was not the only bad actor component of the equipment or that another bad actor component is directly or indirectly giving rise to the usage metrics and/or unscheduled shopping events. The tracking controller can then identify a different, second bad actor component. For example, the tracking controller can determine that another signature matches a different set of unscheduled shopping orders. The tracking controller can then direct that a repair or maintenance action be performed based on the second bad actor component being identified. The tracking controller can continue monitoring the usage metrics and/or unscheduled shopping events to determine whether the correct or all bad actor components have been remediated.

Optionally, a pattern of the usage metrics and/or unscheduled shopping events may be associated with plural potential bad actor components. Additionally or alternatively, the tracking controller can determine that a pattern matches multiple signatures (associated with multiple different bad actor components). These different bad actor components can be weighted relative to each other, such as by a likelihood by which each bad actor component resulted in the usage metrics and/or unscheduled shopping events. For example, a first bad actor component can be associated with a greater likelihood that the first bad actor component is causing the usage metrics and/or unscheduled shopping events than one or more (or all) other bad actor components in the set. The weighting for each bad actor component can be based on the usage metrics and/or unscheduled shopping events. For example, a second bad actor component may be associated with a greater likelihood than a third bad actor component when there are larger usage metrics and/or more unscheduled shopping events for a first part or material than a second part or material.

The tracking controller can select a bad actor component associated with a likelihood or weight that is greater than one or more (or all) other bad actor components that are identified. The tracking controller can then direct or cause the repair or replacement of this selected bad actor component, as described above. If the rate of unscheduled shopping orders continues to exceed the threshold or otherwise not decrease, then the tracking controller can select the next bad actor component having the next greatest likelihood or weight for repair or replacement (e.g., of the remaining identified bad actor components). This process can continue until the decreasing change point occurs or all the bad actor components in the set have been identified and attempted to be repaired or replaced.

In another example, the different bad actor components that are identified can be weighted relative to each other by an expenditure of repairing the bad actor components. Repair of different components may involve replacing different parts, replenishing or using different materials, or the like. Additionally, repair of different components may require personnel of different experience, education, and/or training levels. The different parts, different materials, and/or different personnel can result in the repairs of different components requiring different lengths of time and/or different financial expenditures (e.g., costs). The tracking controller can select the identified bad actor component having a lower or lowest expenditure (e.g., shorter or shortest repair time, less or least expensive to repair, etc.) than one or more (or all) other bad actor components that are identified.

The tracking controller can then direct or cause the repair or replacement of this selected bad actor component. If the decreasing change point does not occur, then the tracking controller can select the bad actor component having the next lower or lowest repair expenditure (e.g., of the remaining identified bad actor components). This process can continue until the rate of unscheduled shopping orders decreases (e.g., exhibits a decreasing change point) or all the bad actor components in the set have been identified and attempted to be repaired or replaced.

In another example, the different bad actor components that are identified can be weighted relative to each other by severities of failure associated with the different components. Some components may be less critical to the continued operation of equipment than others. For example, failure of an ambient temperature sensor, a radio, etc. in a vehicle may be less critical to the continued or safe operation of the vehicle than failure of a brake, throttle, engine, cooling system, or the like. The criticality of the different components may be associated with different severities of failure. Those components that are more critical to the continued and/or safe operation of equipment can be associated with greater severities of failure than components that are less critical to the continued and/or safe operation of the equipment. The severities of failure can be quantified by the tracking controller or manual input assigning different values to the severities of failure.

If multiple bad actor components are identified, the tracking controller optionally may select the identified bad actor component having a severity of failure that is lower than one or more (or all) other bad actor components that are identified. The tracking controller can then direct or cause the repair or replacement of this selected bad actor component. If the decreasing change point is not detected, then the tracking controller can select the bad actor component having the next lower or lowest severity of failure (e.g., of the remaining identified bad actor components). This process can continue until the rate of unscheduled shopping orders decreases (e.g., exhibits a decreasing change point) or all the bad actor components in the set have been identified and attempted to be repaired or replaced.

As another example, the different bad actor components that are identified can be weighted relative to each other by availabilities of repair parts for the repair or replacement of the bad actor components. The repair or replacement of different bad actor components may involve use of different parts and/or materials. But some parts or materials may not be available, may be too costly (e.g., outside of a repair budget), etc. If multiple bad actor components are identified, the tracking controller optionally may select the identified bad actor component where the parts or materials needed for the repair or replacement of the component are available or are more available than the parts or materials needed for the repair or replacement of one or more (or all) other bad actor components. If the rate of unscheduled shopping orders continues to exceed the threshold or otherwise not decrease, then the tracking controller can select the bad actor component needing the parts or materials that are available, but that may not be in as ready supply as the bad actor components. This process can continue until the rate of unscheduled shopping orders decreases (e.g., exhibits a decreasing inflection point) or all the bad actor components in the set have been identified and attempted to be repaired or replaced.

The tracking controller optionally may select which bad actor component to repair or replace by controlling operation of the equipment. As shown in FIG. 1, the tracking controller can communicate (via wired and/or wireless pathways or connections) with an equipment controller 114. The equipment controller represents hardware circuitry that controls operation of the equipment. For example, the equipment controller can be an engine control unit that controls operation of an engine of a vehicle, a computer that controls operation of a medical device or medical imaging device, a controller of a power-generating system (e.g., a turbine engine), or the like. The tracking controller can send signals to the equipment controller to direct the equipment controller to change operation of the equipment.

For example, the tracking controller may identify several bad actor components based on the usage metrics and/or unscheduled shopping events. The tracking controller can direct the equipment controller to control the equipment to test (e.g., stress) a first bad actor component of the bad actor components that are identified. The tracking controller or an operator can monitor performance of the equipment (e.g., via one or more sensors 116) responsive to changing operation of the equipment. Based on performance (e.g., output) of the equipment, the tracking controller may determine to change another operation of the equipment to test (e.g., stress) another bad actor component. This process can be repeated and the performances of the equipment after changing operations to test or stress the different bad actor components examined by the tracking controller. Based on the equipment performances, the tracking controller may select one or more of the bad actor components for repair or replacement.

For example, testing or stressing some bad actor components may cause those bad actor components to fail or may cause output of the equipment to decrease or otherwise change more than testing or stressing other bad actor components. For example, the sensors may detect that the horsepower generated by an engine decreases, the temperature of the equipment increases, the speed of the equipment decreases, etc., more when one bad actor component is stressed than when one or more (or all) other bad actor components are stressed. The tracking controller can select the bad actor component that is associated with a greater or the greatest negative impact on operation of the equipment relative to one or more (or all) other bad actor components when that bad actor component was tested. The selected bad actor component can then be repaired or replaced, as described herein.

One or more of the unscheduled shopping events monitored by the tracking controller (e.g., at 202 in the method 200 and/or at 402 in the method 400) can be pre-repair requests for parts and/or materials. For example, instead of all unscheduled shopping events received at 202, 402 (in the methods described above) being actual shop events, one or more of these unscheduled shopping events can be pre-repair requests for parts or materials. A pre-repair request for parts or materials may be a request for a part or material that is to be used for operation of the equipment, but not for repair or maintenance of the equipment. For example, the pre-repair request can be for parts or materials that are used or consumed by operation of the equipment.

Optionally, a pre-repair request can be a hypothetical request that is not responded to by providing the part or material. Instead, the pre-repair request can be an indication that an operator of the equipment may potentially obtain the part or material, but is not currently seeking to obtain the part or material.

The tracking controller can examine the pre-repair requests in a manner like the unscheduled shopping events described above. For example, the tracking controller may determine that usage metrics and/or unscheduled shopping events that are based on one or more pre-repair requests match a signature of a bad actor component. Although the part or material requested by the pre-repair request is not yet acquired or used with the equipment, the pre-repair request of the part or material can indicate that the request would result in the usage metric used to identify a bad actor component, as described herein.

The tracking controller can then modify the previously scheduled or established schedule of maintenance of the equipment in response to the bad actor component being identified based at least in part on the pre-repair requests. For example, the tracking controller can communicate to a shop facility, operator of the equipment, or the like, a change to the maintenance schedule that involves more frequent inspection of the equipment and/or the bad actor component that was identified. This can permit the tracking controller to simulate what unscheduled shopping orders would result in different bad actor components being identified and to modify the maintenance schedule of the equipment based on the simulation.

In one embodiment, a method (e.g., for identifying a bad actor component needing repair or replacement) is provided that includes tracking unscheduled shopping events for maintenance or repair of first equipment and identifying a segment of the unscheduled shopping events that are tracked. The segment represents a period of time during which the unscheduled shopping events occurred at a rate or frequency. The method also includes determining a usage metric of one or more parts in connection with the unscheduled shopping events occurring during the segment. The usage metric indicates a cumulative amount of usage of the one or more parts in connection with the unscheduled shopping events during the segment for the first equipment relative to the cumulative amount of usage of the one or more parts in connection with the unscheduled shopping events for other equipment in a set of equipment during one or more other segments of equal length. The method also includes identifying a bad actor component in the first equipment based on the usage metric that is determined.

Optionally, at least two of the segments are determined with different rates or frequencies of the unscheduled shopping events occurring during the segments. The method also can include identifying an increasing change point between the segments responsive to the rates or frequencies of the unscheduled shopping events increasing above a threshold percentile within the set of equipment. The rates or frequencies may include a second order derivative of the rate or frequency at which the unscheduled shopping events occur.

In one example, at least two of the segments can be determined with different rates or frequencies of the unscheduled shopping events occurring during the segments. The method also can include identifying a decreasing change point between the segments responsive to the rates or frequencies of the unscheduled shopping events decreasing below a threshold percentile within the set of equipment.

At least two of the segments may be determined with different rates or frequencies of the unscheduled shopping events occurring during the segments. The method also can include identifying a maintenance or repair action performed on the equipment prior to a first segment transitioning to a second segment associated with a reduced rate or frequency of the unscheduled shopping orders, and determining a signature of the usage metric that occurred prior to the first segment transitioning to the second segment. The signature may be a sequence of the usage metric and at least one additional usage metric and times at which the usage metrics occur. The method optionally also can include examining the usage metric for a second equipment in the set of equipment, comparing the usage metric for the second equipment with the signature, and directing performance of the maintenance or repair action on the second equipment based on comparing the usage metric for the second equipment with the signature. Performance of the maintenance or repair on the second equipment may occur prior to the second segment increasing to a third segment associated with a greater rate or frequency of the unscheduled shopping orders.

Optionally, the unscheduled shopping events include maintenance actions performed on the first equipment that are performed based on a detected state of need for maintenance or a prognostic need for maintenance.

The method also may include performing a maintenance or repair action on the first equipment based on the segment that is identified and monitoring additional changes in the usage metric to determine whether the cumulative usage decreases.

The unscheduled shopping events may be associated with a first component of the first equipment, and the method also can include determining a repair associated with a different, second component of the first equipment based on the usage metric and performing the repair on the second component of the first equipment.

In another example, a method includes determining unscheduled shopping events for maintenance or repair of first equipment and usage metrics of parts used in the unscheduled shopping events, comparing one or more of the unscheduled shopping events or the usage metrics of the first equipment with a predefined signature of one or more of unscheduled shopping events or usage metrics of other equipment, determining that the one or more of the unscheduled shopping events or the usage metrics of the first equipment match the signature, and instructing repair or maintenance of the first equipment based on the one or more of the unscheduled shopping events or the usage metrics of the first equipment matching the signature.

Optionally, instructing the repair or maintenance includes sending a notice signal to one or more operators for performing the repair or maintenance.

The signature can be a first signature of plural different signatures associated with different components of the other equipment, and comparing the one or more of the unscheduled shopping events or the usage metrics of the first equipment with the signature may include comparing the one or more of the unscheduled shopping events or the usage metrics of the first equipment with the different signatures to determine which of the components in the first equipment is to be repaired or maintained. The different signatures can represent different sequences of the one or more of the unscheduled shopping events or the usage metrics.

Optionally, the method also includes identifying a plurality of potential causes for a need for the repair or maintenance of the first equipment based on the one or more of the unscheduled shopping events or the usage metrics of the first equipment matching the signature, selecting a first potential cause for the need for the repair or maintenance, and performing the repair or maintenance of a first component of the first equipment based on the first potential cause that is selected. Selecting the first potential cause can include identifying which of the potential causes has a greatest likelihood of repairing the first equipment. The first potential cause may be selected based on different lengths of time needed to perform the repair or maintenance associated with the potential causes for the need for the repair or maintenance. The first potential cause may be selected based on different costs needed to perform the repair or maintenance associated with the potential causes for the need for the repair or maintenance. The first potential cause can be selected based on different severities of failure associated with the potential causes for the need for the repair or maintenance. The first potential cause may be selected based on different availabilities of components used in the repair or maintenance.

In another example, the method can include identifying a plurality of potential causes for a need for the repair or maintenance of the first equipment based on the one or more of the unscheduled shopping events or the usage metrics of the first equipment matching the signature, selecting a first potential cause for the need for the repair or maintenance, controlling a first component of the first equipment based on the first potential cause, examining operation of the first equipment responsive to controlling the first equipment, and one or more of eliminating or confirming the first component as causing the need for the repair or the maintenance based on the operation of the first equipment responsive to controlling the first equipment.

Instructing the repair or maintenance of the first equipment may include changing a movement schedule of the equipment to move the equipment to a shop facility for the repair or maintenance.

The unscheduled shopping events may be pre-repair requests, and the method also can include monitoring additional pre-repair requests for one or more parts or material usage for operation of the first equipment subsequent to the repair or maintenance, comparing the pre-repair requests for the first equipment with the signature or other signatures of other requests for one or more parts or material usage for other equipment, directing another repair or maintenance of the equipment responsive to the additional pre-repair requests matching the signature or the other signatures, and directing the equipment to return to a previously schedule of repair or maintenance responsive to the additional pre-repair requests not matching the signature or the other signatures.

In one example, a system (e.g., that identifies a component in need of repair or replacement) includes one or more processors configured to track unscheduled shopping events for maintenance or repair of first equipment and to identify a segment of the unscheduled shopping events that are tracked. The segment represents a period of time during which the unscheduled shopping events occurred at a rate or frequency. The one or more processors also are configured to determine a usage metric of one or more parts in connection with the unscheduled shopping events occurring during the segment. The usage metric indicates a cumulative amount of usage of the one or more parts in connection with the unscheduled shopping events during the segment for the first equipment relative to the cumulative amount of usage of the one or more parts in connection with the unscheduled shopping events for other equipment in a set of equipment during one or more other segments of equal length. The one or more processors are configured to identify a bad actor component in the first equipment based on the usage metric that is determined. The equipment can be a vehicle or be onboard a vehicle. Optionally, the equipment is non-vehicular equipment.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
tracking unscheduled shopping events for maintenance or repair of first equipment;
identifying a segment of the unscheduled shopping events that are tracked, the segment representing a period of time during which the unscheduled shopping events occurred at a rate or frequency;
determining a usage metric of one or more parts in connection with the unscheduled shopping events occurring during the segment, the usage metric indicating a cumulative amount of usage of the one or more parts in connection with the unscheduled shopping events during the segment for the first equipment relative to the cumulative amount of usage of the one or more parts in connection with the unscheduled shopping events for other equipment in a set of equipment during one or more other segments of equal length; and
identifying a bad actor component in the first equipment based on the usage metric that is determined.

2. The method of claim 1, wherein at least two of the segments are determined with different rates or frequencies of the unscheduled shopping events occurring during the segments, and further comprising identifying an increasing change point between the segments responsive to the rates or frequencies of the unscheduled shopping events increasing above a threshold percentile within the set of equipment.

3. The method of claim 2, wherein the rates or frequencies include a second order derivative of the rate or frequency at which the unscheduled shopping events occur.

4. The method of claim 1, wherein at least two of the segments are determined with different rates or frequencies of the unscheduled shopping events occurring during the segments, and further comprising identifying a decreasing change point between the segments responsive to the rates or frequencies of the unscheduled shopping events decreasing below a threshold percentile within the set of equipment.

5. The method of claim 1, wherein at least two of the segments are determined with different rates or frequencies of the unscheduled shopping events occurring during the segments, and further comprising:
identifying a maintenance or repair action performed on the equipment prior to a first segment transitioning to a second segment associated with a reduced rate or frequency of the unscheduled shopping orders; and
determining a signature of the usage metric that occurred prior to the first segment transitioning to the second segment.

6. The method of claim 5, wherein the signature is a sequence of the usage metric and at least one additional usage metric and times at which the usage metrics occur.

7. The method of claim 5, further comprising:
examining the usage metric for a second equipment in the set of equipment;
comparing the usage metric for the second equipment with the signature; and
directing performance of the maintenance or repair action on the second equipment based on comparing the usage metric for the second equipment with the signature.

8. The method of claim 7, wherein performance of the maintenance or repair on the second equipment occurs prior to the second segment increasing to a third segment associated with a greater rate or frequency of the unscheduled shopping orders.

9. The method of claim 1, wherein the unscheduled shopping events include maintenance actions performed on the first equipment that are performed based on a detected state of need for maintenance or a prognostic need for maintenance.

10. The method of claim 1, further comprising:
performing a maintenance or repair action on the first equipment based on the segment that is identified; and
monitoring additional changes in the usage metric to determine whether the cumulative usage decreases.

11. The method of claim 1, wherein the unscheduled shopping events are associated with a first component of the first equipment, and further comprising:
determining a repair associated with a different, second component of the first equipment based on the usage metric; and
performing the repair on the second component of the first equipment.

12. A method comprising:
determining unscheduled shopping events for maintenance or repair of first equipment and usage metrics of parts used in the unscheduled shopping events;
comparing one or more of the unscheduled shopping events or the usage metrics of the first equipment with a predefined signature of one or more of unscheduled shopping events or usage metrics of other equipment;
determining that the one or more of the unscheduled shopping events or the usage metrics of the first equipment match the signature; and
instructing repair or maintenance of the first equipment based on the one or more of the unscheduled shopping events or the usage metrics of the first equipment matching the signature.

13. The method of claim 12, wherein instructing the repair or maintenance includes sending a notice signal to one or more operators for performing the repair or maintenance.

14. The method of claim 12, wherein the signature is a first signature of plural different signatures associated with different components of the other equipment, and comparing the one or more of the unscheduled shopping events or the usage metrics of the first equipment with the signature includes comparing the one or more of the unscheduled shopping events or the usage metrics of the first equipment with the different signatures to determine which of the components in the first equipment is to be repaired or maintained.

15. The method of claim 14, wherein the different signatures represent different sequences of the one or more of the unscheduled shopping events or the usage metrics.

16. The method of claim 12, further comprising:
identifying a plurality of potential causes for a need for the repair or maintenance of the first equipment based on the one or more of the unscheduled shopping events or the usage metrics of the first equipment matching the signature;
selecting a first potential cause for the need for the repair or maintenance; and
performing the repair or maintenance of a first component of the first equipment based on the first potential cause that is selected.

17. The method of claim 16, wherein selecting the first potential cause includes identifying which of the potential causes has a greatest likelihood of repairing the first equipment.

18. The method of claim 16, wherein the first potential cause is selected based on different lengths of time needed to perform the repair or maintenance associated with the potential causes for the need for the repair or maintenance.

19. The method of claim 16, wherein the first potential cause is selected based on different costs needed to perform the repair or maintenance associated with the potential causes for the need for the repair or maintenance.

20. The method of claim 16, wherein the first potential cause is selected based on different severities of failure associated with the potential causes for the need for the repair or maintenance.

21. The method of claim 16, wherein the first potential cause is selected based on different availabilities of components used in the repair or maintenance.

22. The method of claim 12, further comprising:
identifying a plurality of potential causes for a need for the repair or maintenance of the first equipment based on the one or more of the unscheduled shopping events or the usage metrics of the first equipment matching the signature;
selecting a first potential cause for the need for the repair or maintenance;
controlling a first component of the first equipment based on the first potential cause;
examining operation of the first equipment responsive to controlling the first equipment; and
one or more of eliminating or confirming the first component as causing the need for the repair or the maintenance based on the operation of the first equipment responsive to controlling the first equipment.

23. The method of claim 12, wherein instructing the repair or maintenance of the first equipment includes changing a movement schedule of the equipment to move the equipment to a shop facility for the repair or maintenance.

24. The method of claim 12, wherein the unscheduled shopping events are pre-repair requests, and further comprising:
monitoring additional pre-repair requests for one or more parts or material usage for operation of the first equipment subsequent to the repair or maintenance;
comparing the pre-repair requests for the first equipment with the signature or other signatures of other requests for one or more parts or material usage for other equipment;
responsive to the additional pre-repair requests matching the signature or the other signatures, directing another repair or maintenance of the equipment; and
responsive to the additional pre-repair requests not matching the signature or the other signatures, directing the equipment to return to a previously schedule of repair or maintenance.

25. A system comprising:
one or more processors configured to track unscheduled shopping events for maintenance or repair of first equipment and to identify a segment of the unscheduled shopping events that are tracked, the segment representing a period of time during which the unscheduled shopping events occurred at a rate or frequency, the one or more processors also configured to determine a usage metric of one or more parts in connection with the unscheduled shopping events occurring during the segment, the usage metric indicating a cumulative amount of usage of the one or more parts in connection with the unscheduled shopping events during the segment for the first equipment relative to the cumulative amount of usage of the one or more parts in connection with the unscheduled shopping events for other equipment in a set of equipment during one or more other segments of equal length,
the one or more processors configured to identify a bad actor component in the first equipment based on the usage metric that is determined.

26. The system of claim 25, wherein the equipment is a vehicle or is onboard a vehicle.

27. The system of claim 25, wherein the equipment is non-vehicular equipment.
